(19) United States
(12) Patent Application Publication
(10) Pub. No.: US 2007/0067653 A1
(43) Pub. Date: Mar. 22, 2007

(54) State monitor, configuration control system, cluster, disk array, method of controlling power supply to packages in cluster and computer readable medium

(75) Inventor: Takashi Takemoto, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/476,014

(22) Filed: Jun. 28, 2006

(30) Foreign Application Priority Data
Sep. 21, 2005 (JP) 2005-273005

(51) Int. Cl. G06F 1/00

(52) U.S. Cl. 713/300

(57) ABSTRACT

A state monitor for controlling a power supply to packages in a cluster includes a detector that detects whether the power supply capacity is inadequate to the packages. The state monitor outputs a signal that selectively allows one of the packages to be shut down based on a detection of the detector.

### BACKGROUND OF THE INVENTION

The invention relates to a state monitor, a configuration control system, a cluster, a disk array, a method of controlling a power supply to packages in a cluster and a computer readable medium. For example, this invention relates to a package configuration control scheme of an information processing unit including a plurality of packages in a redundancy configuration, and power supplies for supplying the plurality of packages with power supply voltages, respectively.

An exemplary conventional disk array apparatus is described hereinafter by use of a block diagram in FIG. 7. Referring to FIG. 7, there are two CLS (clusters) #0, #1 of 0-series, and 1-series, respectively, in a redundancy configuration. The CLS #0, #1 each, if broadly divided from a functional point of view, include a host adapter (HA), a disk adapter (DA), a cache (CHE), power supplies, and a state monitor. With the CLS #0, the HA includes, for example, two packages (hereinafter referred to as PKG) 101, 102, the DA includes, for example, two PKGs 201 and 202, and the CHE includes, for example, two PKGs 301 and 302.

The respective PKGs of those HA, DA and CHE are activated upon receiving supply of voltages from, for example, two power supply units. Power supplies 401, 402 each have a function of transmitting state information to state monitor 500, and state monitor 500 monitors the state information from the power supplies, and gives an instruction for stopping operation to all of the PKGs connected to the power supplies within the CLS #0, if a fault occurs to the power supplies.

The CLS #1 of the other 1-series includes similarly respective PKGs, such as HAs 111 and 112, DAs 211 and 212, and CHEs 311 and 312, power supplies 411 and 412, and state monitor 510. State monitor 510 gives an instruction for stopping operation to all of the PKGs connected to the power supplies within the CLS #1 if a fault occurs to the power supplies. State monitors 500 and 510 of CLS #0, #1, respectively, communicate with each other for mutual exchange of information

With such a configuration, if a fault occurs to any of the power supplies, all of the PKGs connected to the relevant power supplies within the relevant CLS are disconnected temporally. Then, as information on respective states of CLS #0, #1, in the respective series, is exchanged between state monitors 500 and 510, a fact that all of the PKGs within one of the CLSs have been disconnected temporally will be notified to the other CLS, whereupon operation is continued by the other CLS. Accordingly, the apparatus is configured so as to maintain operation even if a fault occurs to one of the CLSs.

Such a disk array apparatus is disclosed in JP-A No. 2001-337791 and JP-A No. 2002-268830.

### SUMMARY OF THE INVENTION

The conventional disk array apparatus exemplarily shown in FIG. 7 has many problems including some exemplary problems discussed below. For example, with the apparatus shown in FIG. 7, because it may be difficult to separate the PKGs on a PKG-by-PKG basis against a fault occurring to any of the power supplies, all of the PKGs connected to the relevant power supplies within the CLS may be disconnected temporally.

For example, if a fault occurs to power supply 401 in the CLS #0 of the 0-series during an I/O (input/output) process, and state monitor 500 of the CLS #0 determines that a power supply capacity of power supply 402 is less than a power supply load capacity corresponding to the number of the connected PKGs (that is, the power supply capacity is insufficient), state monitor 500 may send out an operation stop signal to all of the PKGs of the HA, DA, and CHE, respectively. Having received the operation stop signal, HA, DA, and CHE each stop its function. This may mean that all of the PKGs connected to the power supplies of the CLS #0 are disconnected temporally.

Thus, if a fault occurs to the other series with functions (e.g., operating), when the one series remains in as-stopped state, the entire apparatus may halt, thereby considerably deteriorating reliability.

In view of the foregoing and other exemplary problems, drawbacks, and disadvantages of the conventional techniques, it is an exemplary feature of the present invention to provide a state monitor, a configuration control system, a cluster, a disk array, a method of controlling a power supply to packages in a cluster and a computer readable medium which are capable of executing operation high in availability and reliability while keeping redundancy as much as possible in the case of a power supply capacity becoming insufficient upon a fault occurring to a power supply.

The present invention provides a state monitor for controlling a power supply to packages in a cluster, including a detector that detects the power supply capacity is inadequate to the packages, wherein the state monitor outputs a signal that selectively allows one of the packages to be shut down based on a detection of the detector.

The present invention also provides a configuration control system, including the state monitor described above, and a package connection unit that shuts down one of the packages.

The present invention also provides a cluster, including the configuration control system described above, a plurality of the packages that are provided with power, and a power supply that supplies the power to the packages.

The present invention also provides a method of controlling a power supply to packages in a cluster, including detecting the power supply capacity is inadequate for the packages, and outputting a signal that allows one of the packages to be shut down selectively based on the detection.

The present invention also provides a computer readable medium embodying a program for causing a state monitor to perform the method described above. With the invention, operation (function) stoppage on a PKG-by-PKG basis may be enabled, so that the invention can advantageously operate a disk array apparatus with high reliability.

### BRIEF DESCRIPTION OF THE DRAWINGS

The novel and exemplary features believed characteristic of the invention are set forth in the appended claims. The invention itself, however, as well as other exemplary features and advantages thereof, will be best understood by reference to the detailed description which follows, read in conjunction with the accompanying drawings, wherein:

FIG. 1 shows an exemplary functional block diagram showing an exemplary embodiment of the present invention;

FIG. 2 shows an exemplary flow chart showing the exemplary operation of the exemplary embodiment of the present invention;

FIGS. 3A and 3B show an exemplary method of selecting a package (PKG);

FIGS. 4A and 4B show another exemplary method of selecting the PKG;

FIGS. 5A and 5B show yet another exemplary method of selecting the PKG;

FIGS. 6A and 6B show a still further exemplary method of selecting the PKG; and

FIG. 7 shows an exemplary block diagram according to a related art.

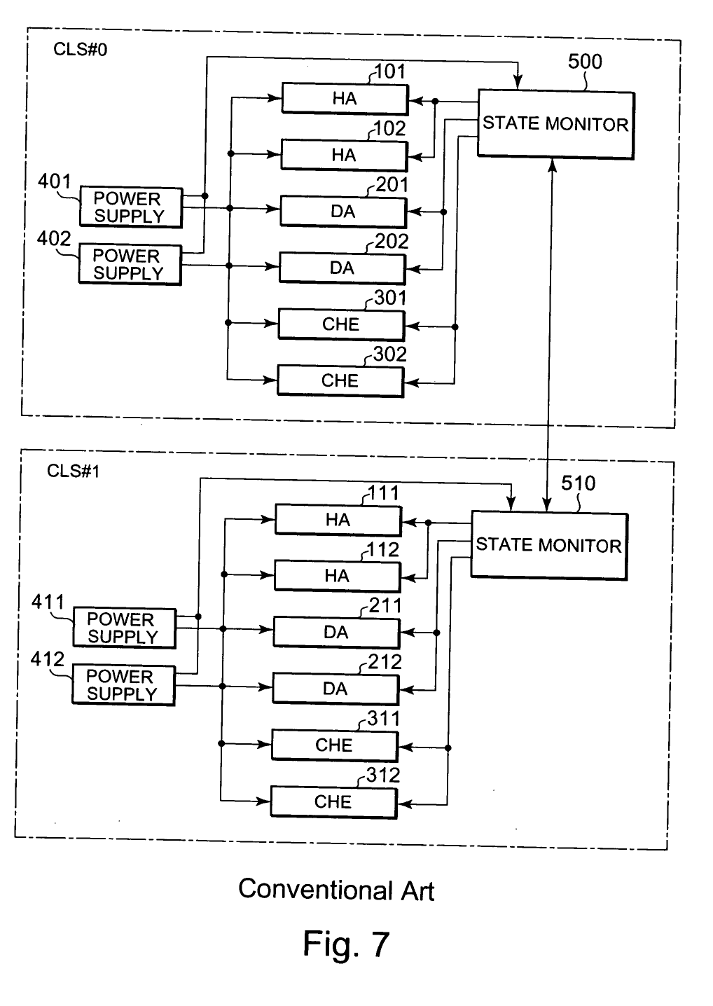

### DETAILED DESCRIPTION OF THE EXEMPLARY EMBODIMENTS

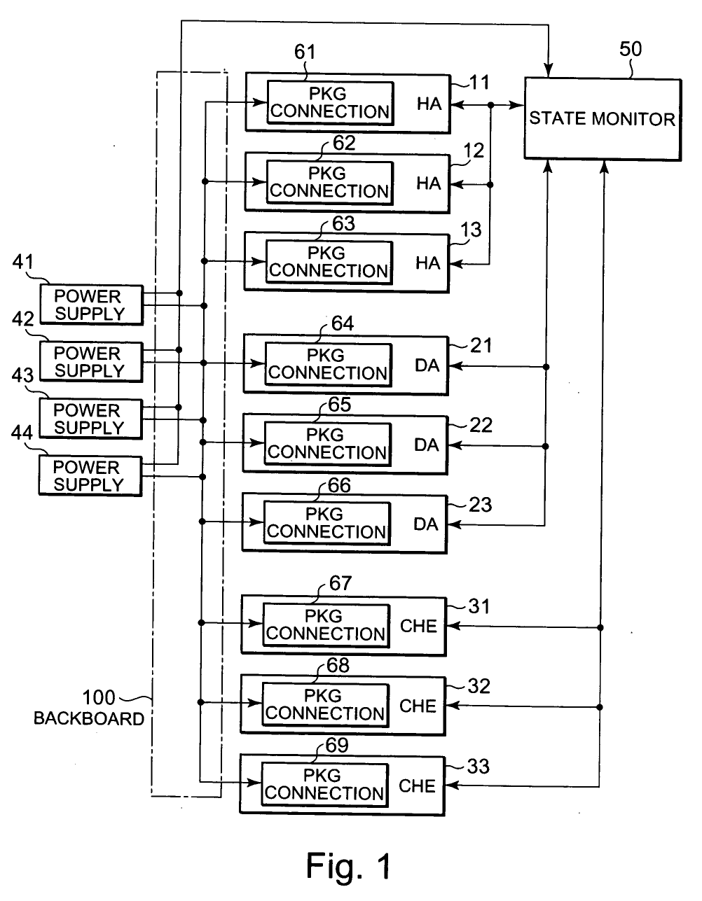

An exemplary embodiment of the present invention is described in detail hereinafter with reference to the accompanying drawings. FIG. 1 is an exemplary block diagram showing the exemplary embodiment of the present invention. Referring to FIG. 1, an exemplary disk array apparatus according to the exemplary embodiment of the present invention, as broadly divided from a functional point of view, may include HAs 11 to 13, DAs 21 to 23, CHEs 31 to 33, power supplies 41 to 44, and state monitor 50. Respective PKGs of those HAs, DAs, and CHEs may be activated by voltages supplied by power supplies 41 to 44, respectively. The power supplies and the PKGs each may have a function of generating a configuration and state information signal for delivering configuration and state information, and transmitting the same to the state monitor 50.

Upon receipt of the configuration and state information signal from the power supplies, and the respective PKGs of HA, DAs, and CHEs, state monitor 50 may compare the number of the power supplies, necessary for the PKGs currently in operation, (that is, a necessary power supply capacity) with the number of the power supplies currently in operation (that is, an actual power supply capacity), and controls separation of the PKGs in order to reduce a load if the number of the power supplies currently in operation, that is, the actual power supply capacity, is found insufficient. In this case, selection of the PKGs to be separated may be executed according to a state of an I/O process, and significance. Thus, the PKGs may be selectively separated (removed) on a package-by-package basis.

For example, PKG connections 61 to 69 may be provided in the respective PKGs of HAs, DAs, and CHEs, and the respective PKGs are supplied with power supply voltages by the power supplies 41 to 44, respectively, via the respective PKG connections 61-69. The respective PKG connections 61-69 may have a function of cutting off supply of the power supply voltages to the PKGs corresponding thereto upon receipt of a stop instruction (an instruction for separation) from state monitor 50. As a result, the respective PKGs of HAs, DAs, and CHEs may be separated from the apparatus (system) on a PKG-by-PKG basis. Reference numeral 100 denotes a part of the unit, corresponding to a backboard.

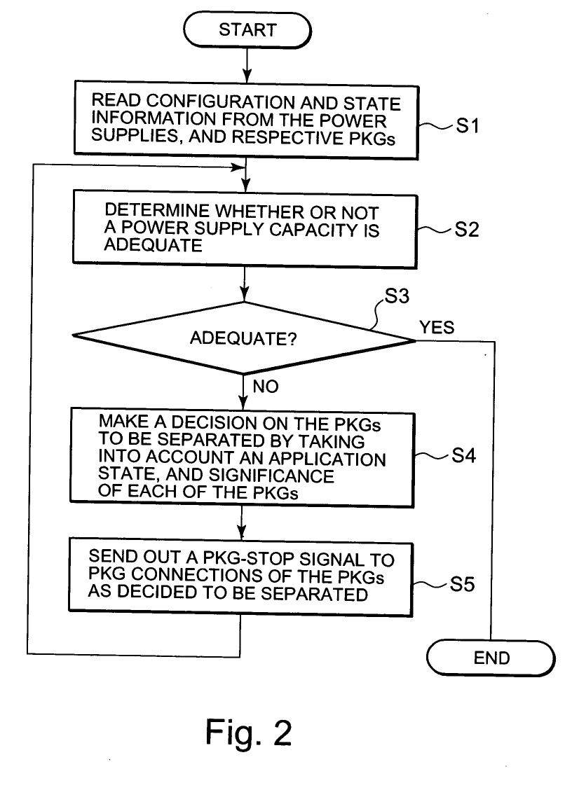

FIG. 2 is an exemplary flow chart showing the operation of the state monitor 50 according to the exemplary embodiment shown in FIG. 1. First, for example, upon receipt of the configuration and state information signal from the power supplies, HA, DA, and CHE, respectively, the state monitor 50 may read contents of respective pieces of information therefrom (step S1). Then, state monitor 50 compares the number of the power supplies, necessary for the PKGs connected at present, (the necessary power supply capacity) with the number of the power supplies currently in operation (the actual power supply capacity), thereby determining whether or not a power supply capacity is adequate (step S2).

If the power supply capacity is found to be adequate as a result of comparison (“Yes” in step S3), then processing is completed. If the same is found to be inadequate, that is, the actual power supply capacity falls short of the necessary power supply capacity (No in step S3), then there is the need for reducing the necessary power supply capacity, so that selective separation of the PKGs may be executed. In such a case, PKGs to be separated may be selected by state monitor 50, for example, according to the state of the I/O process (including an I/O process throughput), and significance among HAs, DAs, and CHEs (step S4).

For example, any of the following exemplary methods may be used.

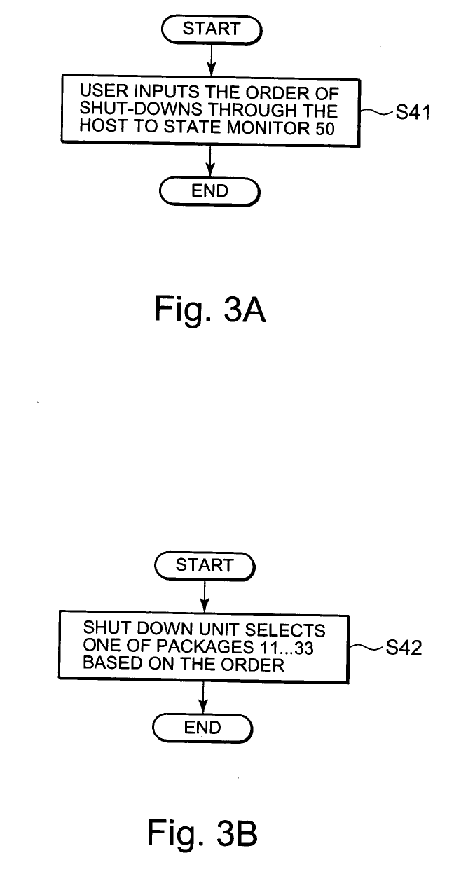

FIGS. 3A and 3B show an exemplary method of selecting a PKG to be separated. In this exemplary method, one of packages 11 . . . 33 is selected based on a predetermined order. Since the significance of each PKG depends on each user, the user inputs the order of shut-downs through the host (not shown) to state monitor 50 (step S41). The shut-down unit (not shown, for example, which is in state monitor 50) selects one of packages 11 . . . 33 based on the order (e.g., the package having least significance) of the user input (step S42).

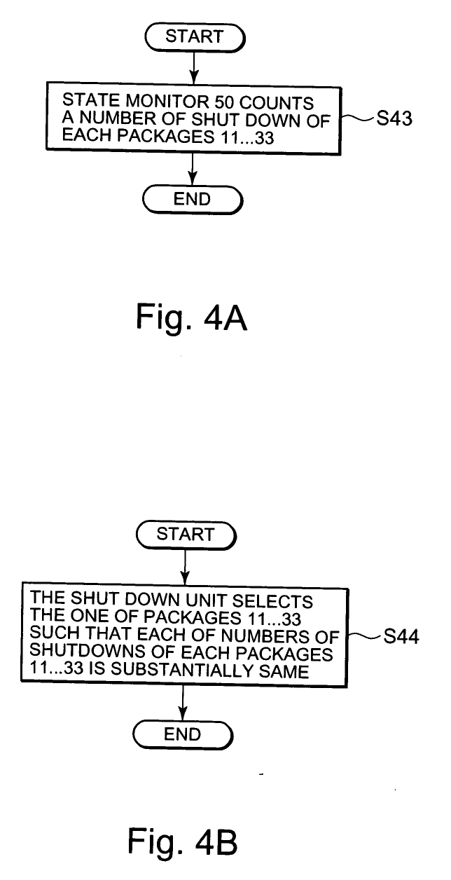

FIGS. 4A and 4B show another exemplary method of selecting the PKG to be separated. In this exemplary method, one of packages 11 . . . 33 is selected based on a rotation of packages (e.g., a so-called “round-robin” method). In the previous failure, state monitor 50 counts a number of shut-downs of each package 11 . . . 33 (step S43). The shut-down unit (not shown, which is in state monitor 50, for example) selects the one of the packages 11 . . . 33 such that each number of shut-downs of each of the packages 11 . . . 33 is substantially equal (step S44).

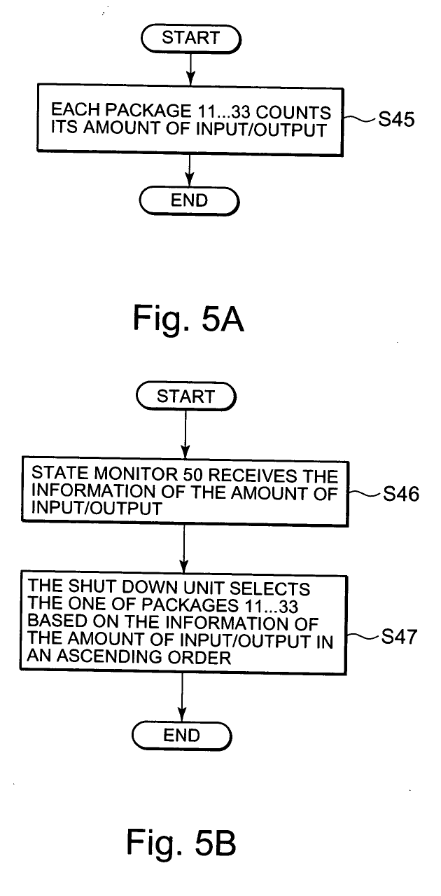

FIGS. 5A and 5B show yet another exemplary method of selecting the PKG to be separated. In this exemplary method, one of packages 11 . . . 33 is selected based on an amount of input/output of each package 11 . . . 33 in an ascending order. The I/O control chip (not shown, which is in each package 11 . . . 33, for example) determines its amount of input/output (step S45). At regular time intervals, state monitor 50 receives the amount of input/output from the I/O chip (step S46) and the shut-down unit selects the one of the packages 11 . . . 33 based on the information of the amount of input/output in an ascending order (step S47). Thus, for example, the package having the lowest input/output is selected first for separation and so forth.

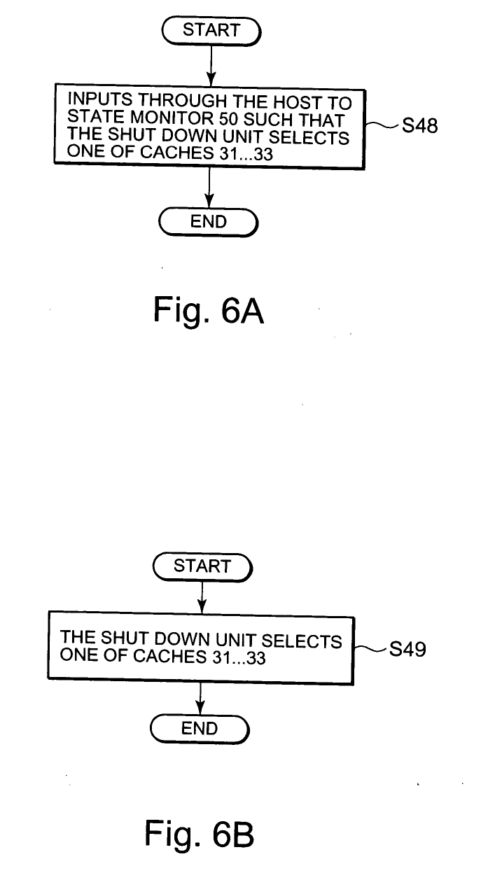

FIGS. 6A and 6B show a still further exemplary method of selecting the PKG to be separated. In this exemplary method, one of packages 11 . . . 33 is selected such that the most PKGs 11 . . . 33 can be kept connected. For example, one of the packages 11 . . . 33 is selected based on a consumption of power supply of each package. Namely, the PKG which consumes the most power supply is selected. For example, CHE 31 . . . 33 may include many DIMMs and consumes much power supply to refresh the memory for the operation. Thus, input is made through the host to state monitor 50 such that CHE 31 . . . 33 is to be selected (step S48). When the supply power is lower than the consumption of power, the shut-down unit selects one of CHEs 31 . . . 33 (step S49).

Though in the exemplary embodiment discussed above, a shut-down unit in the state monitor 50 selects PKG 11 . . . 33, PKG 11 . . . 33 may be selected by each of PKGs 11 . . . 33. Namely, each of PKGs 11 . . . 33 may decide to be shut down itself.

Upon the decision being made on which of the PKG(s) is to be separated (removed from connection), state monitor 50 may send out a signal (e.g., PKG-stop signal) to the respective PKG connection(s) of the PKG(s) to be separated (step S5). The separation of the PKG(s) is thereby executed. As a result of the separation of the PKGs, a decrease occurs in the number of the power supplies (the necessary power supply capacity). Then, the operation may revert to the step S2 again to repeat the processing as above until the power supply capacity is determined to be adequate (“Yes” in step S3). When the power supply capacity becomes adequate, the apparatus (system) in that state maintains a normal operation.

With the invention, operation (function) stoppage on a PKG-by-PKG basis may be enabled, so that the invention has an advantageous effect of operating a disk array apparatus with high reliability. Further, with the invention, automatic comparison of the number of the power supplies, as required, (the necessary power supply capacity) with the number of the power supplies in operation (the actual power supply capacity) may be conducted, thereby selecting the PKGs to be separated according to the state of the I/O process, and the significance thereof. Thus, the invention may include another advantageous effect in that a normal state may be maintained as much as possible without awareness on the part of users (e.g., such operation is transparent to the user).

Referring to FIG. 1, if a fault occurs to, for example, power supply 44, HA 13, and DA 23 are separated by state monitor 50, thereby rendering the power supply capacity adequate. At this point in time, CHE 33 is in the middle of the I/O process, and is therefore excluded from targets for the separation. Further, in the case of an example shown in FIG. 1, the respective numbers of HAs, DAs, and CHEs are each shown to be three, and the number of units of the power supplies is shown to be four, which, it is to be understood, are shown by way of example only, and the invention is therefore not limited to those numbers.

With the example shown in FIG. 1, all of the PKGs are each provided with the PKG connection. Accordingly, there may occur an increase in area (volume) and cost to the extent of an area used for installation of the PKG connection.. For this reason, another exemplary embodiment of the invention may adopt a configuration where PKG connections are mounted on a part of apparatus, corresponding to backboard 100 as shown in FIG. 1, instead of providing the respective PKGs with the PKG connection. By doing so, it may get unnecessary to mount the PKG connection on the respective PKGs, thereby eliminating an increase in the area and cost with respect to each of the PKGs.

With the above-described exemplary embodiments of the invention, the invention has been applied to a disk array apparatus. However, it is evident that the invention may be widely applied to an information processing unit of a computer, and so forth, having a redundancy configuration for enhancement in reliability. Furthermore, it is evident that the operation of state monitor 50 shown in FIG. 1 may be configured such that operation steps thereof in the form of a program may be pre-stored in a record medium such as ROM, and so forth, and a computer (CPU) is caused to read the program to thereby execute the same.

While this invention has been described with reference to exemplary embodiments, this description is not intended as limiting. Various modifications of the illustrative embodiments, as well as other embodiments of the invention, will be apparent to persons skilled in the art upon taking description as a whole. It is, therefore, contemplated that the appended claims will cover any such modifications or embodiments as fall within the true scope of the invention.

Further, the inventor's intent is to encompass all equivalents of all the elements of the claimed invention even if the claims are amended during prosecution.

This application is based on Japanese Patent Application No. 2005-273005 filed on Sep. 21, 2005 and including specification, claims, drawings and summary. The disclosure of the above Japanese Patent Application is incorporated herein by reference in its entirety.

What is claimed is:

1. A state monitor for controlling a power supply to packages in a cluster, comprising:
a detector that detects whether said power supply capacity is inadequate to said packages,
wherein said state monitor outputs a signal that selectively allows one of said packages to be shut down based on a detection of said detector.

2. The state monitor according to claim 1, wherein said signal allows another one of said packages to be shut down, until an actual power supply capacity meets a necessary power supply capacity.

3. The state monitor according to claim 1, further comprising:
a shut-down unit that outputs said signal that selectively allows said one of said packages to be shut down based on said detection of said detector.

4. The state monitor according to claim 1, wherein said package includes one of a host adapter, a disk adapter and a cache.

5. The state monitor according to claim 3, wherein said shut-down unit selects said one of said packages based on a situation of said cluster.

6. The state monitor according to claim 5, wherein said shut-down unit selects said one of said packages based on a predetermined order.

7. The state monitor according to claim 6, wherein:
said state monitor is input with said predetermined order; and
said shut-down unit selects said one of said packages based on said predetermined order.

8. The state monitor according to claim 5, wherein said shut-down unit selects said one of said packages based on a rotation of packages.

9. The state monitor according to claim 8, wherein:
said state monitor counts a number of shut-downs of each packages; and
subsequently said shut-down unit selects said one of said packages for shut down such that each a number of shut downs of each of said packages is substantially equal.

10. The state monitor according to claim 5, wherein said shut-down unit selects said one of said packages based on an amount of input/output of each said package in an ascending order.

11. The state monitor according to claim 10, wherein:
each said package determines said amount of input/output;
said state monitor receives an information of said amount of input/output; and
said shut-down unit selects said one of said packages to be shut down based on said amount of input/output in an ascending order.

12. The state monitor according to claim 5, wherein said shut-down unit selects said one of said packages based on a consumption of power by said each package.

13. The state monitor according to claim 3, wherein said shut-down unit selects a cache for shut down.

14. A configuration control system, comprising:
said state monitor according to claim 1; and
a package connection unit that shuts down one of said packages.

15. The configuration control system according to claim 14, wherein said package connection unit selects said one of said packages based on a situation of said cluster.

16. A cluster, comprising:
a plurality of said packages that are provided with power;
a power supply that supplies said power to said packages; and
a configuration control system comprising a state monitor for controlling said power supply to said packages, said state monitor including:
a detector that detects whether said power supply capacity is inadequate to said packages,
wherein said state monitor outputs a signal that selectively allows one of said packages to be shut down based on a detection of said detector, and

17. The cluster according to claim 16, further comprising:
a package connection unit that shuts down one of said packages,
wherein said package connection unit selects said one of said packages based on a situation of said cluster,
wherein said package connection unit is mounted on said one of said packages.

18. The cluster according to claim 17, further comprising:
a backboard,
wherein said package connection unit is mounted on said backboard.

19. A disk array that includes a cluster according to claim 16.

20. A method of controlling a power supply to packages in a cluster, comprising:
detecting whether said power supply capacity is inadequate for said packages; and
outputting a signal that allows one of said packages to be shut down selectively based on said detecting.

21. The method according to claim 20, wherein said signal allows another one of said packages to be shut down, until an actual power supply capacity meets a necessary power supply capacity.

22. The method according to claim 20, further comprising:
shutting down selectively one of said packages based on said detecting.

23. The method according to claim 20, wherein said package includes one of a host adapter, a disk adapter and a cache.

24. The method according to claim 22, further comprising:
selecting said one of said packages based on a situation of said cluster.

25. The method according to claim 23, further comprising:
selecting said one of said packages based on a predetermined order.

26. The method according to claim 24, further comprising:
inputting a predetermined order to said state monitor,
wherein said selecting comprises selecting said one of said packages based on said order.

27. The method according claim 24, wherein said selecting comprises:
selecting said one of said packages based on a rotation of packages.

28. The method according claim 27, further comprising:
counting a number of shut downs of each package of said packages; and
subsequently selecting said one of said packages Such that each number of shut downs of each of said packages is substantially equal.

29. The method according to claim 24, further comprising:
selecting said one of said packages based on an amount of input/output of each said package in an ascending order.

30. The method according to claim 29, further comprising:
determining said amount of input/output; and
selecting said one of said packages to be shutdown based on said amount of input/output in said ascending order.

31. The method according to claim 24, further comprising:
selecting said one of said packages based on a consumption of power by said each package.

32. The method according to claim 31, further comprising:
selecting a cache.

33. The method according to claim 20, further comprising:
reading configuration and state information from said power supply and said packages.

34. A computer readable medium embodying a program for causing a state monitor to perform the method of claim 20.
